(19) United States
(12) Patent Application Publication
(10) Pub. No.: US 2007/0257962 A1
(43) Pub. Date: Nov. 8, 2007

(54) Printer with Embroidering Function

(75) Inventors: Masao Ogawa, Aichi-ken (JP); Hiroshi Kitazawa, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi, Aichi-ken (JP)

(21) Appl. No.: 10/599,549

(22) PCT Filed: Jan. 27, 2005
(86) PCT No.: PCT/JP05/01108

§ 371 Date: Jul. 3, 2007

(30) Foreign Application Priority Data
Mar. 29, 2004 (JP) 2004-096836

(51) Int. Cl. B41J 2/165

(52) U.S. Cl. 347/33; 347/100; 347/108; 347/20

(57) ABSTRACT

A printer with embroidering function includes a sewing machine body 2 capable of sewing a workpiece cloth W, a cloth holding frame 3 that holds the workpiece cloth W to be sewn, a frame drive unit 4 having the cloth holding frame 3 connected therewith to move the cloth holding frame 3 independently in two perpendicular directions in a horizontal plane, the printer with embroidering function further including an ink-jet printing unit detachably a tached to an attachment portion 4a of the frame drive unit 4 separated from the sewing machine body 2 capable of printing the workpiece cloth W of the cloth holding frame 3 moved by the frame drive unit 4 and a head cap 52, a purging mechanism 53, a nozzle wiper 54, an ink receptacle 55 and a waste-ink absorbing felt 56.

### TECHNICAL FIELD

The present invention is directed to a printer with embroidering function having a sewing machine body, a cloth holding frame, a frame drive unit, and an ink-jet printing unit.

### BACKGROUND ART

Conventionally, an embroidery sewing machine includes a sewing machine body including a sewing needle capable of sewing a workpiece cloth, a needle bar, a needle bar vertical drive mechanism, a loop taker mechanism; a cloth holding frame that stretches and holds a workpiece cloth to be sewn; and a frame drive unit having the cloth holding frame connected therewith and driving the cloth holding frame independently in two perpendicular directions in a horizontal plane. In a household embroidery sewing machine, the frame drive unit is attached to a bed of the sewing machine body.

It has been conventionally conceived to mount an ink-jet printer to the embroidery sewing machine. In such case, a print head of the printing unit is positioned in the proximity of the workpiece cloth of the cloth holding frame connected to the frame drive unit. The cloth holding frame is carried in the horizontal direction by the frame drive unit, and printing is enabled by ejecting ink on embroidery patterns formed on the workpiece cloth by the printing unit (For example, embroidery sewing machines disclosed in JP-A-5-272046, hereinafter referred to as patent document 1 and JP-A-9256260, hereinafter referred to as patent document 2 are known).

The embroidery sewing machine disclosed in patent document 1, is an industrial sewing machine having a laterally elongated sewing machine frame provided on top of a sewing machine table, a plurality of sewing machine heads connected to the front surface of the sewing machine frame and a plurality of print heads connected vertically movably to the rear surface of the sewing machine frame. The cloth holding frame is placed on the sewing machine table and is moved in the horizontal direction by a frame drive unit. In switching between a sewing state and a printing state, the cloth holding frame is moved (offset) in the longitudinal direction by the distance between the sewing needle and the print head.

The embroidery sewing machine disclosed in patent document 2 is an industrial sewing machine having a needle bar case provided in the sewing machine bed; a plurality of needle bars supported vertically movably by the sewing needle case; the plurality of needle bars being selectively switched to an active position by moving the needle case. In such sewing machine, at least one needle bar in the needle bar case is replaced by the print head. The print head is provided with a movable head which is moved vertically by the vertical drive mechanism.

An ink-jet printer requires maintenance operations such as a flushing operation and a purging operation in order Lo maintain smooth ink ejection from the print head. A flushing operation is an operation in which the print head is regularly moved toward an ink absorbing material to eject ink on the ink absorbing material from the print head nozzle in order to prevent the nozzle from drying. A purging operation is an operation in which the print head is regularly moved toward a suction mechanism to suck air bubbles from the nozzle by the suction mechanism.

### DISCLOSURE OF THE INVENTION

### Problem to be Overcome by the Invention

However, the embroidery sewing machines described in the aforementioned patent documents 1 and 2 do not disclose any means of maintenance operations, hence may be doubtful as to the capability of executing satisfactory maintenance operations. In a maintenance operation, the workpiece cloth, needless to say, needs to be kept clean. Also, when printing the workpiece cloth held by an embroidery frame having vertical volume, avoiding interference between the embroidery frame, the print head and the maintenance mechanism is a critical requirement. However no such problems are addressed in the disclosures.

An object of the present invention is to provide a printer with embroidering function having features that enabling both workpiece sewing and workpiece printing without having to rearrange the hold of the workpiece cloth by the cloth holding frame; provide a print head maintenance mechanism that enables execution of maintenance operation while executing a print operation; and adapt the embroidery sewing machine for household use without increasing the overall size.

### Means for Overcoming the Problem

A printer with embroidering function of the present invention includes a sewing machine body capable of sewing a workpiece cloth, a cloth holding frame holding the workpiece cloth to be sewn, a frame drive unit having the cloth holding frame connected therewith to move the cloth holding frame independently in two mutually perpendicular directions on a horizontal plane, the printer with embroidering function having an ink-jet printer capable of printing the workpiece cloth of the cloth holding frame moved by the frame drive unit comprising a purging mechanism capable of purging a print head of the printing unit; a carrier mechanism characterized by being capable of switching the purging mechanism or the print head between a purging position capable of purging the print head and a printable position spaced from the purging position and capable of printing by relatively moving the purging mechanism or the print head in a horizontal direction.

According to the above construction, the provision of the sewing machine body capable of sewing the workpiece cloth; the cloth holding frame that holds the workpiece cloth to be sewn; the frame drive unit that has the cloth holding frame connected therewith to move the cloth holding frame independently in two perpendicular directions in the horizontal plane; and the ink-jet printing unit capable of printing the workpiece cloth of the cloth holding frame moved by the frame drive unit enables both sewing and printing of the workpiece cloth without having to rearrange the hold of the workpiece cloth by the cloth holding frame. Also, the above construction allows the cloth held by the cloth holding frame to be held in a consistent manner during the printing and embroidering process, thereby maintaining proper positioning between the associated sewing and printing patterns. Also, provision of the purging mechanism that performs purging operation on the print head, and a carrier mechanism capable of switching the purging mechanism or the print head between the purging position capable of purging the purging mechanism or the print head and a printable position spaced from the purging position and allowing execution of print operation by relative movement of the purging mechanism and the print head in the horizontal direction allows the purging mechanism or the print head to be reliably switched to the purging position, thereby allowing purging of the print head and reliably remove debris and dust from the nozzles of the print head.

### BRIEF DESCRIPTION OF THE DRAWINGS

FIG. 1 is a plan view of a sewing machine body and a frame drive unit illustrating a first embodiment of the present invention;

FIG. 2 is a front view of the sewing machine body and the frame drive unit in FIG. 1;

FIG. 3 is a plan view of the frame drive unit and a printing unit in separated state;

FIG. 4 is a front view of the frame drive unit and the printing unit;

FIG. 5 is a plan view of the frame drive unit and the printing unit (nonprinting state) in connected state;

FIG. 6 is a front view of the frame drive unit and the printing unit in FIG. 5;

FIG. 7 is a plan view of the frame drive unit and the printing unit (printing state) in connected state;

FIG. 8 is a front view of the frame drive unit and the printing unit in FIG. 5;

FIG. 9 is a block diagram of a control system of the frame drive unit, the sewing machine body, and the printing unit;

FIG. 10 is a plan view of a sewing machine body of the printer with embroidering function illustrating a second embodiment of the present invention;

FIG. 11 is a front view of the sewing machine body and the frame drive unit in FIG. 10;

FIG. 12 is a plan view of the frame drive unit and a printing unit (printable state) in a connected state;

FIG. 13 is a front view of the frame drive unit and the print unit in FIG. 12;

FIG. 14 is a vertical sectional view of a main portion (purgable state) of the printing unit;

FIG. 15 is a vertical sectional view of a main portion (printable state) of the printing unit;

FIG. 16 is vertical sectional view of a main portion (flushable state) of the printing unit;

FIG. 17 is a block diagram of a control system of the frame drive unit, the sewing machine body, and the printing unit;

FIG. 18 is a plan view of a printer with embroidering function illustrating a third embodiment of the present invention;

FIG. 19 is a front view of the printer with embroidering function in FIG. 18;

FIG. 20 is a plan view of the printer with embroidering function (sewable state);

FIG. 21 is a front view of the printer with embroidering function in FIG. 20;

FIG. 22 is a plan view of the printer with embroidering function (printable state); and

FIG. 23 is a front view of the printer with embroidering function in FIG. 21.

### BEST MODE FOR CARRYING OUT THE INVENTION

For the purpose of explaining the present invention in detail, a description will be given in accordance with the accompanying drawings.

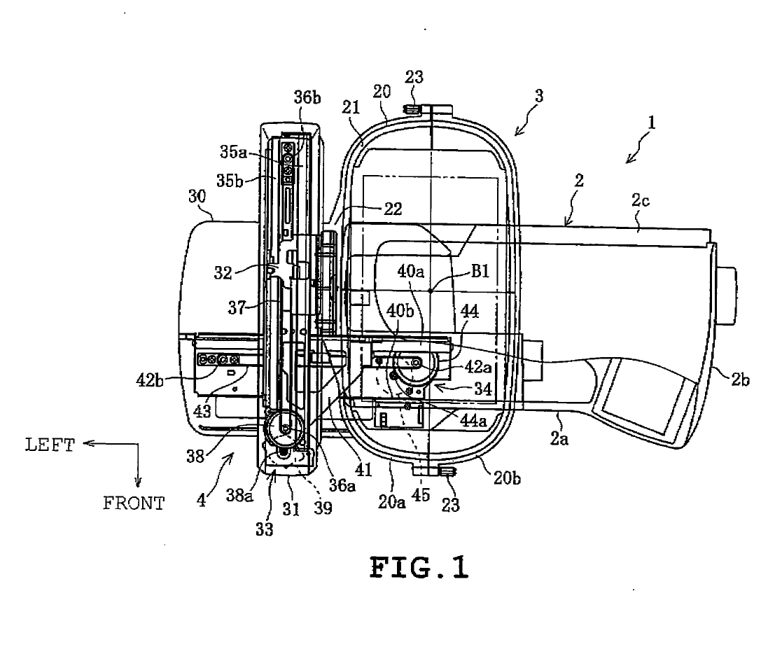

FIGS. 1 to 9 illustrate a first embodiment of the present invention.

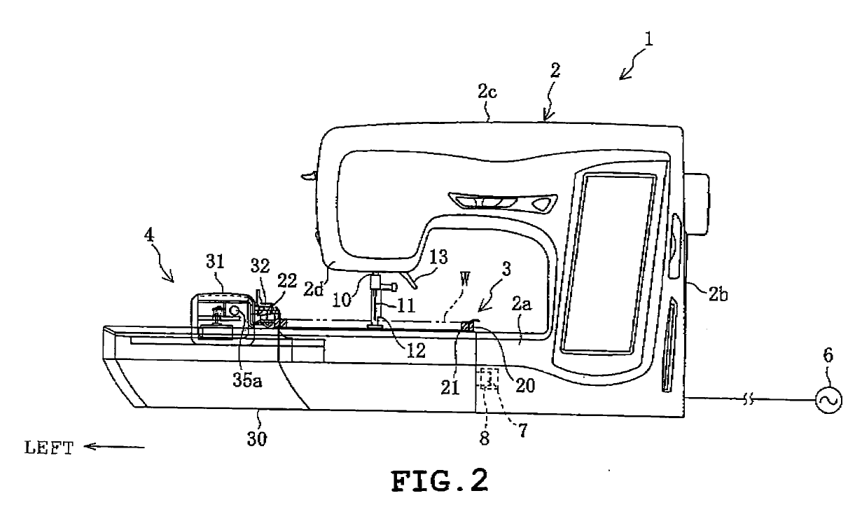

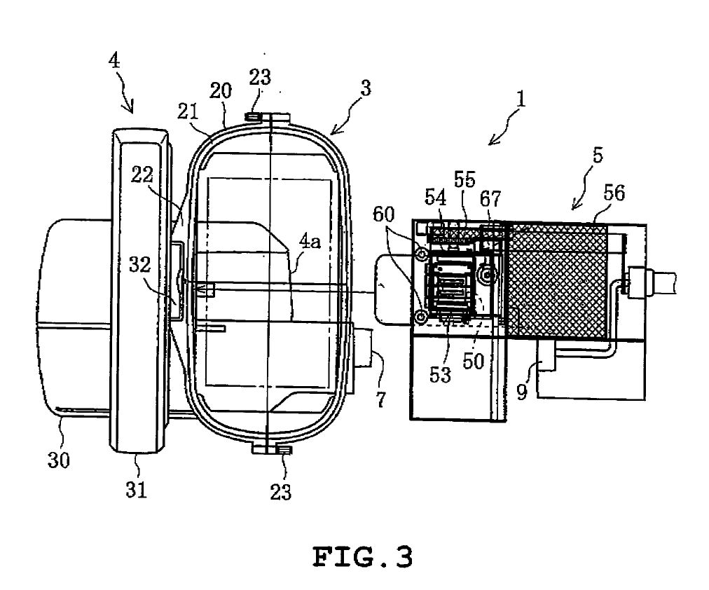

A printer with embroidering function, as shown in FIGS. 1 and 2, includes a sewing machine body 2 capable of sewing a workpiece cloth W, a cloth holding frame 3 that holds the workpiece cloth to be sewn, a frame drive unit 4 that moves cloth holding frame 3 in two perpendicular directions in a horizontal plane, and an ink-jet printing unit 5(refer to FIGS. 3 to 8). The frame drive unit 4 has an attachment portion 4a detachably attached to the sewing machine body 2, and establishes connection with the cloth holding frame 3 to move the same independently in the longitudinal and lateral directions (two perpendicular directions in the horizontal plane). The printing unit 5, as shown in FIGS. 3 to 8, is detachably attached to the attachment portion 4a of the frame drive unit 4 separated from the sewing machine body 2, and is capable of printing the workpiece cloth W of the cloth holding frame 3 being moved by the frame drive unit 4.

First, a description will be given on the sewing machine body 2.

As shown in FIGS. 1 and 2, the sewing machine body 2 has a bed 2a, a foot 2b standing on the right portion of the bed 2a, an arm 2c leftwardly extending from the upper portion of the foot 2b so as to confront the bed 2a, and a head 2d provided in the left portion of the arm 2c. A needle bar 10 is supported vertically movably to the head 2d, and a sewing needle 11 is attached to the lower end of the needle bar 10. Also, the head 2d is provided with a cloth presser 12 and a presser operating lever 13 operated to vertically move the cloth presser 12.

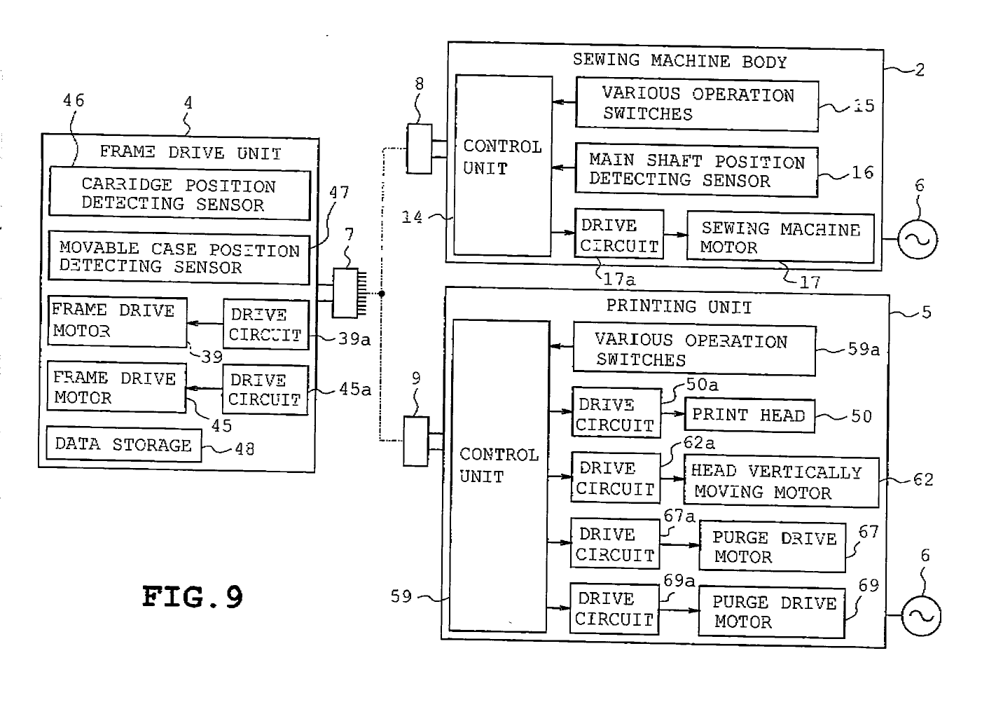

Also, as shown in FIG. 9, the sewing machine body 2 includes a control unit 14, various operation switches 15, a main shaft position detecting sensor 16, a sewing machine motor 17, and a drive circuit 17a for the sewing machine motor 17. Electricity is supplied to the sewing machine body 2 from a household power supply 6. The sewing machine motor 17 rotationally drives the main shaft (not shown) and the needle bar 10 is driven in a vertically reciprocating manner by a needle bar vertical drive mechanism (not shown), thereby to form a seam on the workpiece cloth by the cooperation of the sewing needle 11 of the needle bar 10 and a loop taker provided in the bed 2a.

Next, a description will be given on the cloth holding frame 3.

As shown in FIGS. 1 to 8, the cloth holding frame 3 has an outer frame 20, an inner frame 21 fitting into the outer frame 20 and a connecting portion 22 connecting disconnectably to the frame drive unit 4. The outer frame 20 comprises an outer-frame left-half portion 20a and an outer-frame right-half portion 20b. Both front and rear ends of the outer-frame left-half portion 20a and the outer-frame right-half portion 20b are connected by a pair of fastening screws 23, and the connection portion 22 is formed integrally to the outer-frame left half portion 20a. When holding the workpiece cloth W by the cloth holding frame 3, normally, the workpiece cloth W is set on the outer frame 20 with the inner frame 21 removed from the outer frame 20 and the inner frame 21 is thereafter fitted into the inner side of the outer frame 20 from above. Then, the inner frame 21 is fitted completely into the outer frame 20 and the pair of fastening screws 23 is tightened with the workpiece cloth W in a stretched state, thus completing the workpiece cloth attachment (holding).

Next, an explanation will be given on the frame drive unit 4.

A shown in FIGS. 1 to 8, the frame drive unit 4 includes a main body case 30 in a substantially U-shape in plan view, a movable case 31 elongated in the longitudinal direction provided movably in the lateral direction on the main body case 30, a carriage 32 attached movably in the longitudinal direction on the movable case 31, a longitudinal drive mechanism 33 that drives the carriage 32 i n the longitudinal direction, and a lateral drive mechanism 34 that drives the movable case 31 and the carriage 32 in the lateral direction. The main body case 30 has the attachment portion 4a attached detachably to the bed 2a of the sewing machine body 2, formed thereto. The carriage 32 has a connection portion 22 of the cloth holding frame 3 connected disconnectably thereto.

The movable case 31 has two guide members 35a and 35b, elongated in the longitudinal direction, provided therein; and the carriage 32 is guided and supported by the guide members 35a and 35b. The longitudinal drive mechanism 33 has a pair of pinions 36a and 36b, an endless belt 37 wound on the pinions 36a and 36b and connected to the carriage 32, a gear 38 fixed coaxially with the pinion 36a, and a frame drive motor 39 that rotationally drives a drive gear 38a placed in mesh engagement with the gear 38.

The main body case 30 has two guide members 40a and 40b, elongated in the lateral direction, provided therein; and a movable body 41 is guided by the guide members 40a and 40b, the movable body 41 being connected to the movable case 31. The lateral drive mechanism 34 has pinions 42a and 42b, an endless belt 43 wound on the pinions 42a and 42b connected to the movable body 41, a gear fixed coaxially with the pinion 42a, and a frame drive motor 45 that rotationally drives a drive gear 44a in mesh engagement with a drive gear 44a.

Also, as shown in FIG.9, the frame drive unit 4 is provided with a carriage position detecting sensor 46, a movable case position detecting sensor 47, drive circuits 39a and 45a for the frame drive motors 39 and 45, and data storage portion 48. The data storage portion 48 is a storage medium for tentatively storing data of embroidery patterns sewn by attaching the sewing machine body 2 to the frame drive unit 4, and data of print patterns printed by the printing unit 5 attached to the frame drive unit 4. In forming a printing pattern associated with an embroidery pattern on the same portion of the workpiece cloth W, such data can be used effectively. However, the data storage portion 48 can be omitted.

A frame drive unit connector 7 and a sewing machine body connector B are provided for connecting electrical systems of the frame drive unit 4 and the sewing machine body 2. The frame drive unit connector 7 and the sewing machine body connector 8 are connected automatically and separated by attachment/detachment of the sewing machine body 2 to/from the frame drive unit 4. When the frame drive unit connector 7 and the sewing machine body connector 8 are connected, a control unit 14 of the sewing machine body 2 establishes a connection between the sensors 46 and 47 of the frame drive unit 4, the drive circuits 39a and 45a, and the data storage portion 48. Thus, electricity is supplied to the frame drive unit 4 from the household power supply 6 via the sewing machine body 2, thereby controlling the drive of the frame drive motors 39 and 45 by the control unit 14.

Next a description will be given on the printing unit 5.

As shown in FIGS. 3 to 8, the printing unit 5 includes a bed 5a, a bed connecting portion 5b connecting to the right side of the bed 5a, a foot 5c standing on the right portion of the bed connecting portion 5b, an arm 5d extending leftward from the upper portion of the foot 5c so as to confront the bed connection portion 5b, and a head 5e provided in the left portion of the arm 5d. The bed 5a has the attachment portion 4a of the frame drive unit 4 attached detachably thereto. The bed 5a also has a cloth positioning portion 5f formed as a projection situated in the mid portion of the bed 5a upper surface. The head 5e, having an elongated longitudinal profile, protrudes forward with respect to the arm 5d.

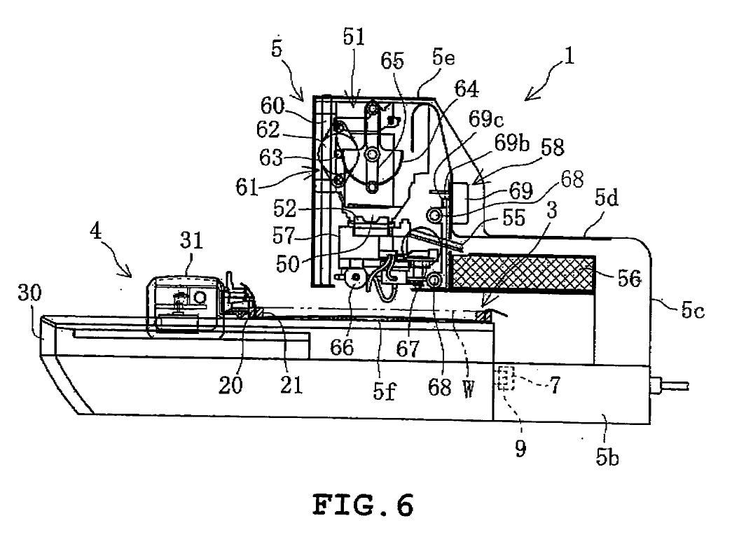

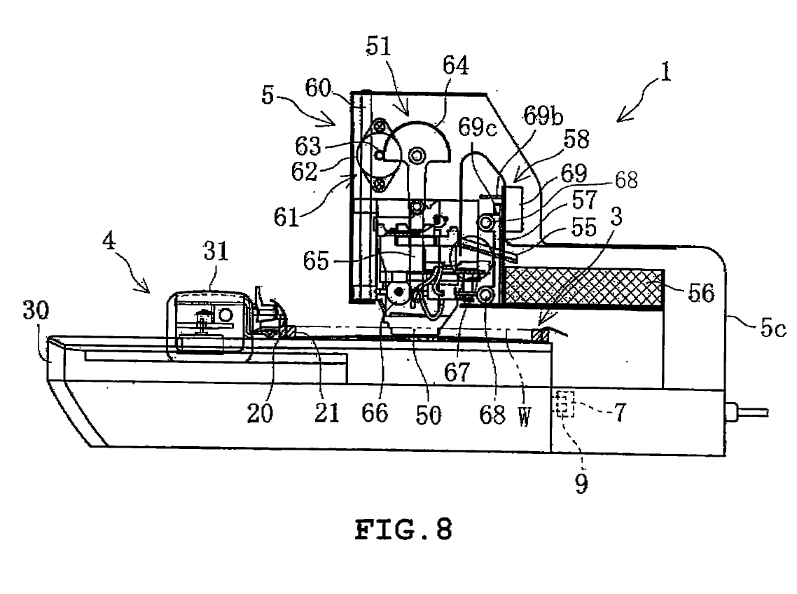

The printing unit 5 includes a print head 50, a head position switch mechanism 51, and various maintenance mechanisms executing maintenance operations on the print head 50. The maintenance mechanism includes a head cap 52 that covers the nozzle of the print head 50, a purging mechanism 53 for executing a later described purging operation, a nozzle wiper 54 that wipes off the ink accumulated on the nozzle, an ink receptacle 55 that receives the ink at the time of a later described flushing operation, arid a waste-ink absorbing felt 56 that absorbs waste ink. A purging operation is an operation executed at consistent intervals by a suction mechanism where ink containing air bubbles are sucked out of every nozzle in order to remove the air bubbles in the nozzles of the print head 50. On the other hand, a flushing operation is an operation to prevent drying of the nozzles of the print head 50 where the print head 50 is moved at consistent intervals to the ink receptacle 55 to draw ink onto the ink absorbing material from every nozzle of the print head 50. The aforementioned printing unit 5 executes color printing by ejecting four colors of ink from the print head 50. The head position switch mechanism 51 switches the print head 50 between a printing position (refer to FIG. 8) in the proximity of the workpiece cloth W of the cloth holding frame 3 connected to the frame drive unit 4, which is further attached to the printing unit 5, and the nonprinting position (refer to FIG. 6) upwardly spaced from the printing position. The ink receptacle 55 receives ink drawn from the print head 50 by the flushing operation. The waste-ink absorbing felt 56 absorbs waste ink drawn from purging and flushing operations.

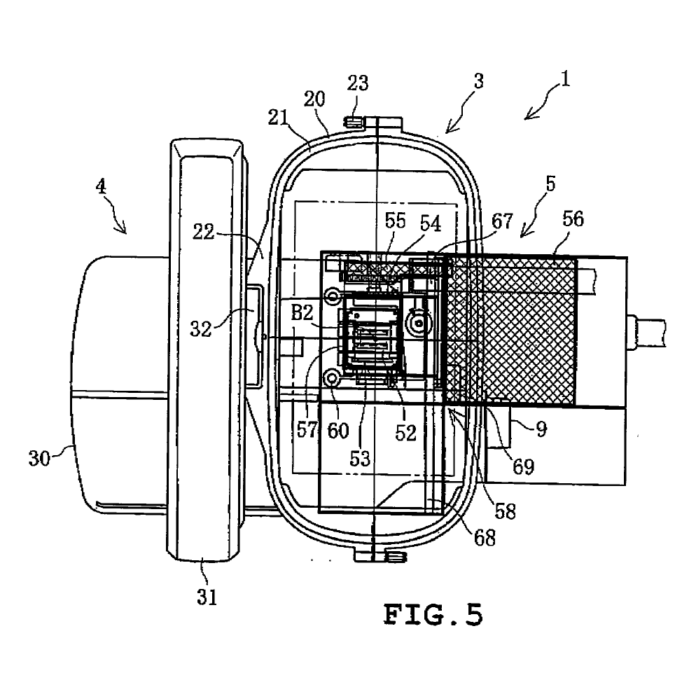

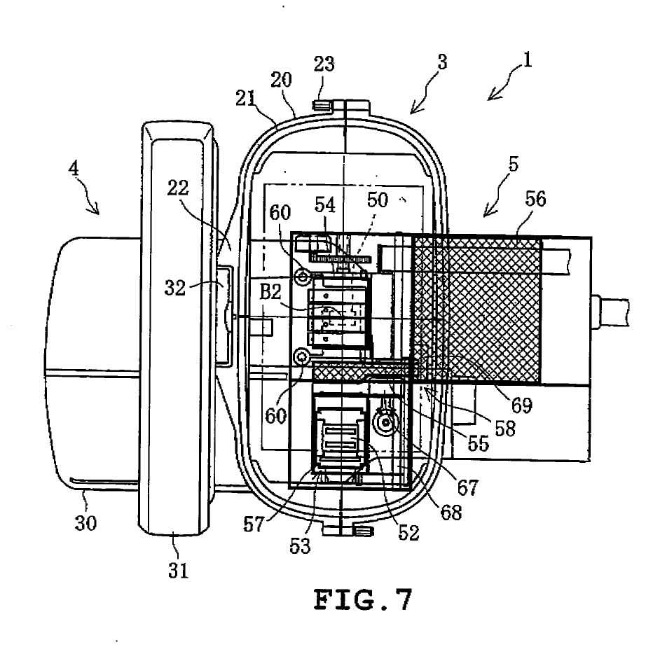

The head cap 52, the nozzle wiper 54, and the ink receptacle 55 are provided in the purging mechanism 53, and the attachment of the foregoing members 52 to 55 to the casing constitute the purge unit 57. The printing unit 5 is provided with a carrier mechanism 58 that carries the purging mechanism 53 (in other words, purge unit 57) longitudinally relative to the print head 50. The carrier mechanism 58 is arranged to switch the purging mechanism 53 between the purging position (refer to FIG. 5) allowing execution of purging operation, a printable position (refer to FIG.7) spaced forward relative to the purging position and allowing execution of print operation, and a flushing position (interposing the purging position and the printable position) allowing reception of ink drawn from the flushing operation by the ink receptacle 55.

Also, as shown in FIG.9, the printing unit 5 includes a control unit 59, various operation switches 59a, the print head 50, the head vertically moving motor 62, a purge drive motor 67, a purge carrier motor 69, and drive circuits 50a, 62a, 67a and 69a. The printing unit 5 receives supply of electricity from the household power supply 6. The frame drive unit connector 7 and the printing unit connector 9 are provided to connect the electrical systems of the frame drive unit 4 and the printing unit 5. The frame drive unit connector 7 and the printing unit connector 9 become connected/disconnected by the attachment/detachment of the printing unit 5 to/from the frame drive unit 4.

Under such construction, when the frame drive unit connector 7 and the printing unit connector 9 are connected, the control unit 59 of the printing unit 5 establish connection with the sensors 46 and 47 of the frame drive unit 4, the drive circuits 39a and 45a, and the data storage 48. Thus, the sewing machine body connector 8 and the printing unit connector 9 assume the same structure.

The print head 50 is provided in the rear portion of the head 5e. The print head 50 has four nozzle arrays associated with four colors namely, black, cyan, yellow, and magenta; and each nozzle array has, for example, seventy-five downwardly oriented nozzles aligned in a zigzag profile at 300 dpi. Each nozzle is provided with a piezoelectric ceramic actuator, which bends in response to the drive circuit 50a receiving printing instructions outputted by the control unit 59, to pressurize the ink to be ejected from the nozzle.

The print head 50 has a cartridge attachment portion provided integrally in the upper side thereof. The cartridge attachment portion accommodates four ink cartridges, each supplying four colors of ink to the nozzle of the corresponding color in an exchangeable manner. A print head which does not employ a piezoelectric ceramic actuator may be applied to the print head 50.

The head position switch mechanism 51 is provided in the rear portion of the head 5e. The head position switch mechanism 51 includes front-rear pair of vertically oriented guide rods 60 (corresponding to guide portions) guiding the print head 50 vertically movably, a head vertical drive mechanism 61 including a head vertically moving motor 62 driven electrically to vertically drive the print head. The head vertical, drive mechanism 61 includes the head vertically moving motor 62, a crank member 64 pivoted about a horizontal shaft of a head 5e frame and having formed thereto a sector gear in mesh engagement with the drive gear 63 of the head vertically moving motor 62, and a link member 65 having one end linked rotatably to a lever end of the crank member 64 and the other end linked rotatably to the print head 50.

The print head 50, when fully moved downward by the head vertical drive mechanism 61, assumes a printing position. On the other hand, the print head 50, when fully moved upward, assumes a nonprinting position, whereby a space allowing accommodation of a purge unit 57 is defined under the print head 50 inside the head 5e. When the purge unit 57 occupies the space, the purging mechanism 53 assumes the purging position.

The head cap 52 comprises a rubber made cap capable of being closely attached to the head cap 52. When the head cap 52 is lifted by the purge drive motor 67 with the print head 50 in the nonprinting position and the purging mechanism 53 in the purging position, the nozzles of the print head 50 are covered by the head cap 52 and enclosed thereby. When a purging operation is executed in a nonprinting state, the nozzles of the print head 50 are covered by the head cap 52. Instead of lifting the print head 50, the print head 50 may be lowered by the head vertically moving motor 62 so as to cover the nozzles of the print head 50 by the head cap 52.

The purging mechanism 53 includes the head cap 52, the suction pump 66, the purge drive motor 67 that vertically moves the head cap 52 and drives the suction pump 66. When the purge drive motor 67 is driven with the print head 50 in the nonprinting position and the purging mechanism 53 in the purging position, the head cap 52 is lifted, thereby to covered enclose the nozzles of the print head 50. Subsequently, when the suction pump 66 is driven and the interior of the head cap 52 is situated in a negative pressure, small amount of ink as well as air bubbles and debris are sucked away from the nozzles and channels of the print head 50.

The nozzle wiper 54 is provided in the opposite side (further rearward of the head cap 52) of the printable position relative to the head cap 52 of the purging mechanism 53 in the purging position and at level with the nozzles of the print head 50 assuming the nonprinting position. After purging the print head 50 with the purging mechanism 53, upon carrying the purging mechanism 53 from the purging position to the printable position by the carrier mechanism 58, the nozzles are placed in contact with the nozzle wiper 54 and wiped thereby. Thus, ink remaining in the surface of the nozzle is cleaned by executing a purging operation.

The ink receptacle 55 comprises an open-top container disposed in a rightwardly downward incline, and is situated in the purging position side (rearward relative to nozzle wiper 54) relative the nozzle wiper 54, with the purging mechanism 53 disposed in the printable position. The waste-ink absorbing felt 56 is provided in the arm 5d. When the purging mechanism 53 is switched to the flushing position by the carrier mechanism 58, the ink receptacle 55 is disposed under the print head 50. The waste-ink absorbing felt 56 is disposed in the right side of the ink receptacle 55 irrespective of the position of the purging mechanism 53, and the ink received by the ink receptacle 55 is drained down the ink receptacle 55 to be absorbed by the waste-ink absorbing felt 56.

Inside the head 5e, a pair of upper and lower guide rails 68 is disposed in the longitudinal direction, so as to extend fully across the longitudinal length of the head 5e, and a purge unit 57 is guided by the guide rails 68. The purge unit 57 has half the longitudinal length of the head 5e.

The carrier mechanism 58 is provided inside the head 5e and is provided with an electric purge carrier motor 69 that drives the purge unit 57 including the purging mechanism 53, and the like, in the longitudinal direction. The purge carrier motor 69 is fixed laterally to a frame disposed in the longitudinal mid portion of the head 5e, and a pinion 69b is mounted on the output shaft of the purge carrier motor 69, the pinion 69b being placed in mesh engagement with a rack 69c formed in the right end upper surface of the purge unit 57.

The printer with embroidering function 1, as shown in FIG. 1, is arranged so that a predetermined sewing base position B1 of the sewing needle 11, when the sewing machine body 2 is attached to the frame drive unit 4, matches a predetermined printing base position B2 of the print head 50, as shown in FIGS. 5 and 7, when the printer 5 is attached to the frame drive unit 4. When the frame drive unit 4 is attached to the sewing machine body 2, the sewing base position B1 is set so that the sewing needle 11 matches with the center of the maximum movement area covered by the cloth holding frame 3 moved to the maximum extent by the frame drive unit 4. Further, when tho printing unit 5 is attached to the frame drive unit 4, the printing base position B2 is set so that the center of the print head 50 matches with the center of the aforementioned maximum movement area. The center of the print head 50 indicates the center of the plurality of nozzles of the print head 50.

The cloth holding frame 3 being the subject of determining the sewing base position B1 and the printing base position B2 has a predetermined shape and size adapted for, or expected to be adapted for embroidery sewing and printing the workpiece cloth w by the sewing machine body 2 and the printing unit 5. The shape and size is arranged so that the sewing needle 11 and the center of the print head 50 matches with the center of the cloth holding frame 3 connected with the carriage 32, with the movable case 31 is disposed at the center of the lateral movable range and the carriage 32 is disposed at the center of the longitudinal movable range.

Next, a description will be given on the operation and effect of the printer with embroidering function 1.

The attachment portion 4a of the frame drive unit 4 is detachably attached to the bed 2a of the sewing machine body 2. As shown in FIGS.1 and 2, the electrical system of the sewing machine body 2 shown in FIG. 9 and the electrical system of the frame drive unit 4 are connected by the connectors 7 and 8 with the frame drive unit 4 attached to the sewing machine body 2. Thereafter, frame drive motors 39 and 45 are driven by the control unit 14 of the sewing machine body 2, thereby moving the cloth holding frame 3 connected to the frame drive unit 4 independently in the longitudinal and lateral directions while vertically driving the needle bar 10 in a reciprocating manner by driving the sewing machine motor 17 by the control unit 14 to form embroidery patterns on the workpiece cloth W held by the cloth holding frame 3.

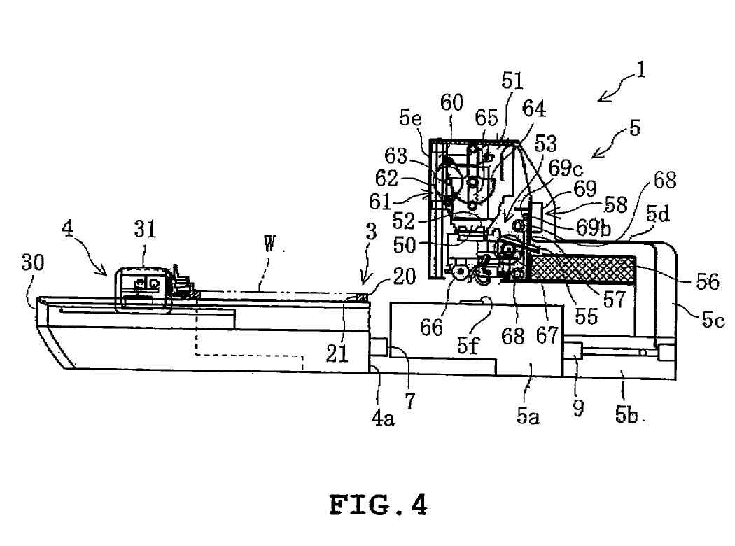

On the other hand, the printing unit 5 is detachably attached to the attachment portion 4a of the frame drive unit 4 separated from the sewing machine body 2. As shown in FIGS. 5 to 8, the electrical systems of the printing unit 5 and the frame drive unit 4 shown in FIG. 9 are connected by the connectors 7 and 9 with the printing unit 5 connected to the frame drive unit 4 as shown in FIGS. 5 to 8. In case the printing unit 5 is not attached to the frame drive unit 4 as shown in FIGS. 3 and 4 or when a print operation is not executed even if the printing unit 5 is attached to the frame drive unit 4, the print head 50 is disposed in the nonprinting position and the purging mechanism 53 (purge unit 57) is disposed in the purging position with the nozzles of the print head 50 being covered by the head cap 52.

The print head 50 is disposed in the nonprinting position and the purging mechanism 53 is disposed in the purging position, when removing the printing unit 5 from the frame drive unit 4 also, thereby creating a relatively large space between the bed 5a and the head 5e. Thus, the printing unit 5 can be reliably attached to/detached from the frame drive unit 4 without the print head 50, or the like, interfering with the cloth holding frame 3 attached to the frame drive unit 4. When the printing unit 5 is attached to the frame drive unit 4, a cloth positioning portion 5f of the bed 5a contacts the workpiece cloth W from the underside, thereby stretching at least the printing portion of the workpiece cloth W so as to maintain appropriate spacing with the print head 50.

When a printing process is executed with the printing unit 5 attached to the frame drive unit 4, first, the purge drive motor 67 is driven by the control unit 59 while maintaining the state of FIGS. 5 and 6, thereby executing a purging operation on the print head 50 by the purging mechanism 53. Then, purging carrier motor 69 is driven by the control unit 59 and the purging mechanism 53 is carried forward from the purging position to be switched to the printable position by the carrier mechanism 58, at which point the nozzles of the print head 50 are wiped by the nozzle wiper 54 provided in the purge unit 57.

In case a flushing operation is to be executed on the print head 50 after wiping the print head 50, the purging mechanism 53 is carried forward from the purging position to be switched to a flushing position. The ink receptacle 55 provided in the purge unit 57 is positioned below the nozzle of the print head 50 to receive the ink ejected from the nozzle by the flushing operation, where after the waste ink is drained down the ink receptacle 55 and absorbed by the waste-ink absorbing felt 56. After executing the flushing operation, the purging mechanism 53 is switched to the printable position.

Next, the head vertically moving motor 62 is driven by the control unit 59 to lower the print head 50 from the nonprinting position by the head position switch mechanism 51 and switched to the printing position as shown in FIGS. 7 and 8. Thereafter, the frame drive motors 39 and 45 of the frame drive unit 4 are driven by the control unit 59 of the printing unit 5 based on printing data, thereby moving the cloth holding frame 3 connected to the frame drive unit 4 independently in the longitudinal and lateral directions. The print head 50 is driven by the control unit 59 to print the workpiece cloth W held by the cloth holding frame 3 and the embroidery pattern formed on the workpiece cloth W.

In flushing the print head 50 at appropriate intervals during the printing process, the printing process is tentatively stopped and the print head 50 is lifted to the nonprinting position by the head position switch mechanism 51. Then, the purge unit 53 is switched to the flushing position by the carrier mechanism 58; where after the flushing operation is executed and the purging mechanism 53 is thereafter switched to the printable position by the carrier mechanism 58. The printing process is restarted after the print head 50 is lowered to the printing position by the head position switch mechanism 51.

The above described printer with embroidery sewing function 1 is characterized in that the attachment portion 4a of the frame drive unit 4 is detachably attached to the sewing machine body 2, the printing unit 5 is detachably attached to the attachment portion 4a of the frame drive unit 4 separated from the sewing machine body 2, thereby executing print operation by the printing unit 5 on the workpiece cloth w held by the cloth holding frame 3 moved by the frame drive unit 4. Such construction allows a selective and moreover easy and reliable attachment of the sewing machine body 2 and the printing unit 5 to the frame drive unit 4, thereby enabling execution of both sewing and printing on the workpiece cloth W without having to rearrange the hold of the workpiece cloth W to the cloth holding frame 3.

Also, the position of the sewing needle 11 when the sewing machine body 2 is attached to the frame drive unit 4, and the position of the print head 50 when the printing unit 5 is attached to the frame drive unit 4 can be arranged substantially the same, thereby allowing both sewing and printing of the workpiece cloth W to be executed without having to offset the cloth holding frame 3. Thus, the size of the frame drive unit 4 can be reduced as well as the manufacturing cost therefore. Further, positioning precision of the embroidery pattern and the printing pattern formed on the workpiece cloth W can be improved.

Also, the predetermined sewing base position B1 of the sewing needle 11 when the sewing machine main body 2 is attached to the frame drive unit 4 and the predetermined printing base position B2 of the print head 50 when the printing unit 5 is attached to the frame drive unit 4 are matched. Thus, embroidery patterns can be formed on the workpiece cloth W based on the sewing base position B1 by attaching the sewing machine body 2 to the frame drive unit 4, and printing patterns can be formed on the workpiece cloth W and embroidery patterns formed on the workpiece cloth W based on the printing base position B2 by attaching the printing unit 5 to the frame drive unit 4, thereby allowing embroidery patterns and printing patterns to be reliably formed in the desired position.

Further, the sewing base position B1 have been set to the position where sewing needle 11 matches with the center of the maximum movement area when the cloth holding frame 3 is moved to the maximum extent by the frame drive unit 4, and the printing base position B2 have been set to the position where the center of the print head 50 matches with the center of the maximum movement area. Thus, sewable area sewable by the sewing machine body 2, the printable area printable by the printing unit 5, and the overlapping area of the sewable area and the printable area can be increased with respect to the cloth holding frame 3 moved by the frame drive unit 4 while also achieving the size reduction of the frame drive unit 4.

Also, the sewing machine body connector 8, among the connectors 7 and 8 that connect the electrical systems of the frame drive unit 4 and the sewing machine body 2, and the printing unit connector 9, among the connectors 7 and 9 that connect the electrical systems of the frame drive unit 4 and the printing unit 5 have been arranged in the same structure. Thus, the frame drive unit connector 7 can be rendered as a common connector connectable to both the sewing machine body connector 8 and the printing unit connector 9, thereby simplifying the connection of the electrical systems between the frame drive unit 4 and the sewing machine body 2 and between the frame drive unit 4 and the printing unit 5, and also reducing the manufacturing cost.

On the other hand, the printing unit 5 is provided with a head position switch mechanism 51 that switches the print head 50 between the printing position in close proximity of the workpiece cloth W held by the cloth holding frame 3 which is further connected to the frame drive unit 4 having the printing unit 5 attached thereto and the nonprinting position spaced from the printing position. Thus, the print head 50 can be switched reliably to the printing position allowing the printing of the workpiece cloth W with the printing unit 5 attached to the frame drive unit 4, and to the nonprinting position to allow attachment/detachment of the printing unit 5 to/from the frame drive unit 4.

The printing unit 5 is provided with the purging mechanism 53 that purges the print head 50, and the carrier mechanism 58 capable of switching the purging mechanism 53 between the purging position capable of purging the purging mechanism 53 and the printable position spaced from the purging position and allowing the execution of the print operation by moving the purging mechanism 53 longitudinally relative to the print head 50. Thus, the purging mechanism 53 can be switched reliably to the purging position, purge the print head 50 and reliably remove debris and dust from the nozzles of the print head 50.

Further, the nozzle wiper 54 of the print head 50 is provided in the purging mechanism 53 so that the print head 50 is wiped by the nozzle wiper 54 when the purging mechanism 53 is carried from the purging position to the printable position by the carrier mechanism 58. Thus, upon moving the purging mechanism 53 from the purging position to the printable position, after purging the print head 50, the ink remaining in the nozzle surface of the print head 50 after the purging operation can be cleaned reliably by wiping the print head 50 with the nozzle wiper 54.

Furthermore, since the ink receptacle 55 that receives the ink flushed from the print head 50 is provided in the purging mechanism 53, and the carrier member 58 is arranged to be capable of switching the purging mechanism 53 to the flushing position allowing reception of ink flushed from the ink receptacle 55, the print head 50 is flushed reliably, thereby reliably preventing the clogging of the nozzles. The head position switch mechanism 51, being provided with guide rods 60 guiding the print head 50 vertically movably and a head vertically moving motor 62 vertically driving the print head, is capable of reliably switching the print head 50 between the printing position and the nonprinting position.

Also, since the printing unit 5 is capable of executing color printing by ejecting plurality of ink from the print head 50, color printing patterns can be formed on the workpiece cloth W held by the cloth holding frame 3 moved by the frame drive unit 4 and on the embroidery patterns formed on the workpiece cloth W, with the printing unit 5 attached to the frame drive unit 4. Further, since the cartridge attachment portion capable of receiving the ink cartridge thereto is integrally provided in the print head 50 of the printing unit 5, ink can be supplied to the nozzles of the print head 50 from the ink cartridges by attaching the ink cartridges to the cartridge attachment portion of the print head 50.

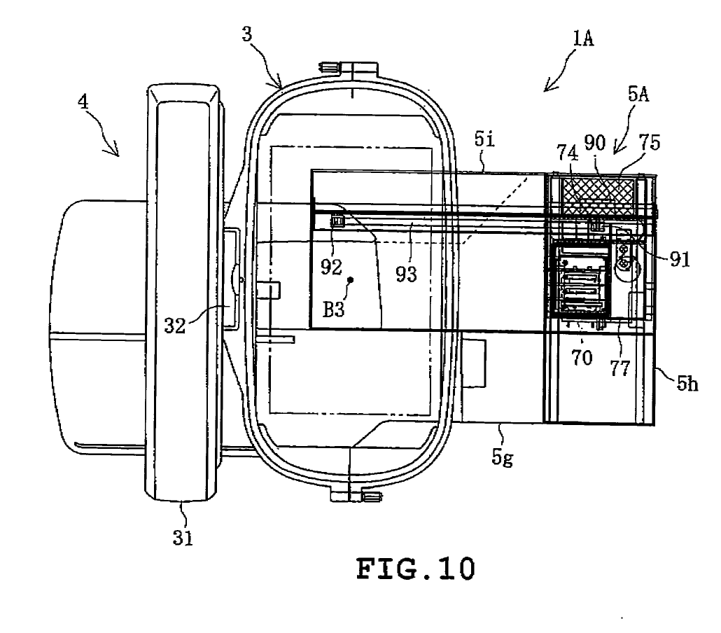

Next, a second embodiment of the present invention will be described with reference to FIGS. 10 to 17. The portions identical to the first embodiment have been represented by the same reference symbols.

The printer 1A with embroidering function, as shown in FIGS. 1 and 2, includes a sewing machine body 2 capable of sewing a workpiece cloth W, a cloth holding frame 3 that holds the workpiece cloth to be sewn, a frame drive unit 4 having an attachment portion 4a detachably attaching to the sewing machine body 2 and having the cloth holding frame 3 connected therewith to move the cloth holding frame 3 in the longitudinal direction and the lateral direction(two perpendicular directions in the horizontal plane), and a printing unit 5A(refer to FIGS. 10 to 13) detachably attaching to the attachment portion 4a of the frame drive unit 4 separated from the sewing machine body 2. The printing unit 5A is an ink-jet printing unit capable of printing the workpiece cloth W held by the cloth holding frame 3 moved by the frame drive unit 4.

The sewing machine body 2, the cloth holding frame 3 and the frame drive unit 4 of the printer with embroidering function 1A are identical to the sewing machine body 2, the cloth holding frame 3 and the frame drive unit 4 of the printer with embroidering function 1 of the first embodiment, therefore have been represented by the reference symbols identical to the first embodiment and hence will not be described in detail.

A description will be given on the printing unit 5A.

As shown in FIGS. 10 to 16, the printing unit 5A includes a bed 5g, a foot 5h standing on the right portion of the bed 5g, an arm 5i extending leftward from the upper portion of the foot 5h so as to confront the bed 5g. The bed 5g has an attachment portion 4a of the frame drive unit 4 attached detachably thereto. The bed 5a also has a cloth positioning portion 5j,formed as a projection, provided thereto.

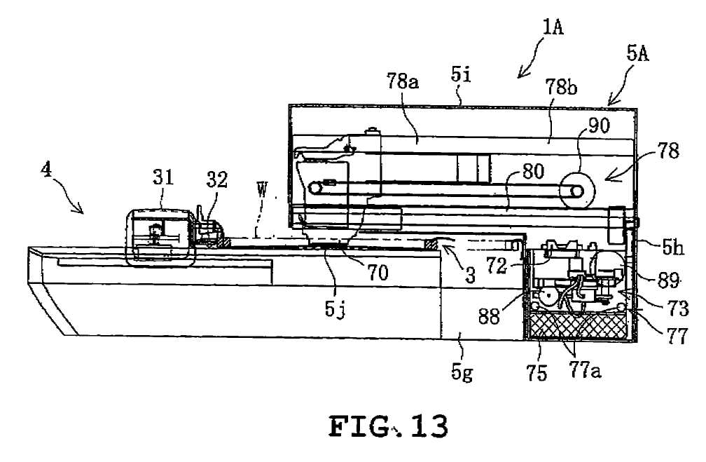

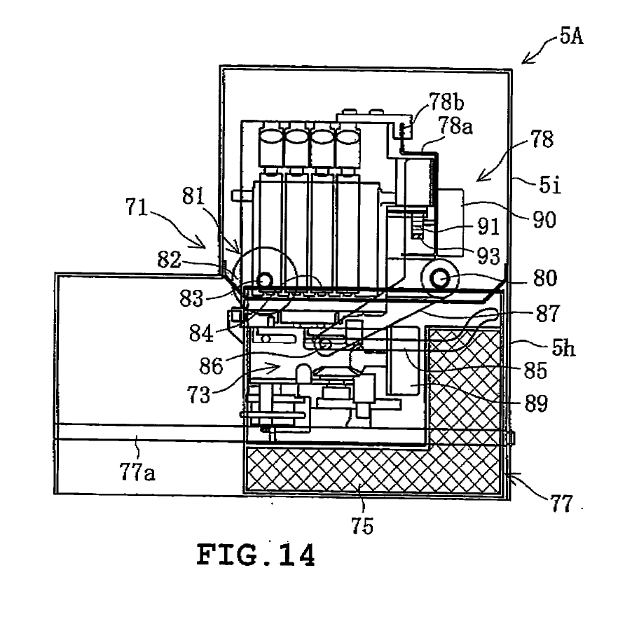

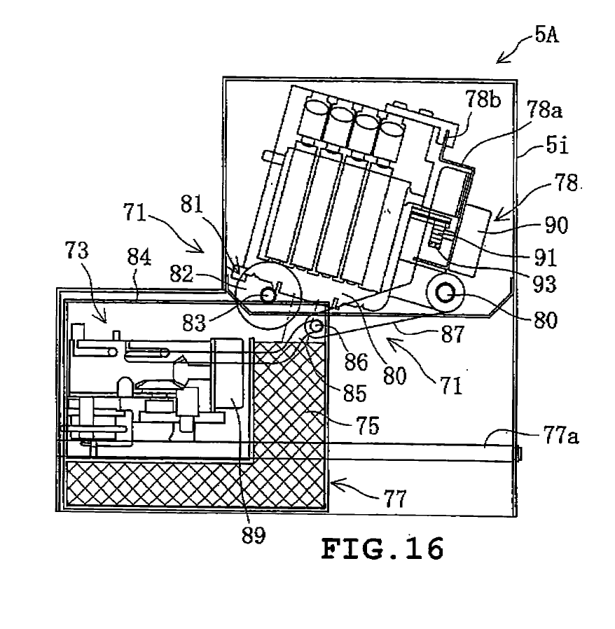

The printing unit 5A includes a print head 50, a head position switch mechanism 71, ahead cap 72 that covers the nozzle of the print head 70, a purging mechanism 73 for purging the print head 70, a nozzle wiper 74 of the print head 74, and a waste-ink absorbing felt 75 that receives and absorbs ink flushed from the print head 70. The print head 70 is capable of color printing by ejecting four colors or ink from the print head 70. The head position switch mechanism 71 is arranged to switch the print head 70 between the printing position (refer to FIGS. 13 and 14) in close proximity of the workpiece cloth W held by the cloth holding frame 3 which is connected to the frame drive unit 4 having the printing unit 5A attached thereto and the nonprinting position (refer to FIG. 16) spaced from the printing position.

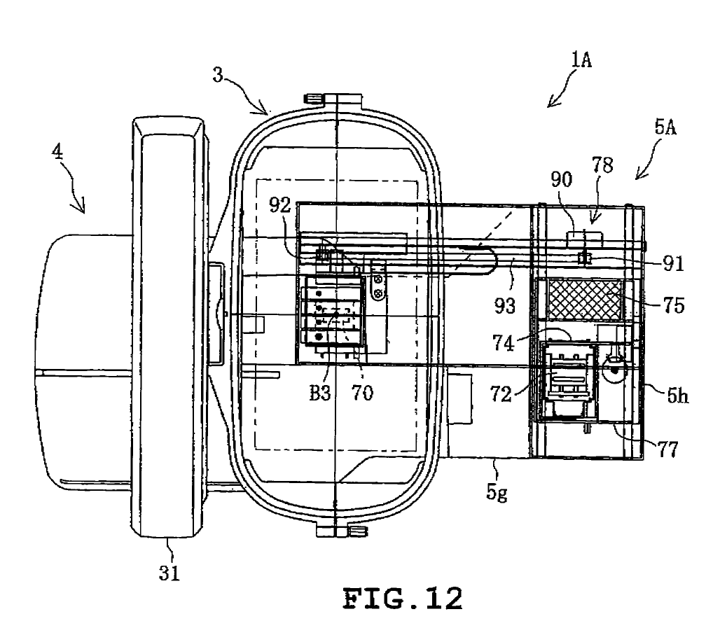

The head cap 72, the nozzle wiper 74, the waste-ink absorbing felt 75 are provided in the purging mechanism 73, and the purge unit 77 is constituted by attaching the foregoing members 72 to 75 to a casing. The purge unit 77 is disposed inside the foot 5h, and the print head 70 is disposed inside the arm 5i. The printing unit 5A is provided with a carrier mechanism 78 that carries the print head 70 laterally relative to the purging mechanism 73 (in other words, purge unit 77), thereby switching the print head 70 between the purging position (refer to FIG. 10) capable of executing a purging operation, and a printable position (refer to FIG. 12) spaced leftward relative to the purging position and allowing the execution of the print operation.

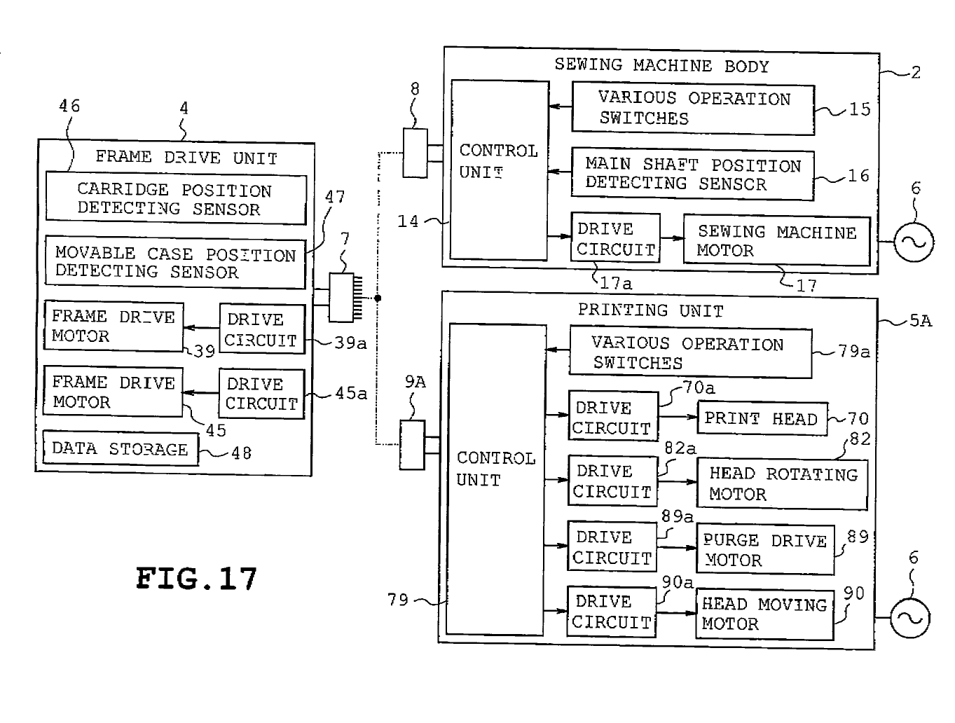

Also, as shown in FIG. 17, the printing unit 5A includes a control unit 79, various operation switches 79a, the print head 70, the head rotating motor 82, a purge drive motor 89, a purge carrier motor 90, and drive circuits 70a, 82a, 89a and 90a for the purge carrier motor 90. Electricity is supplied to the printing unit 5A from the household power supply 6. The frame drive unit connector 7 and a printing unit connector 9A are provided to connect the electrical systems of the frame drive unit 4 and the printing unit 5A. The frame drive unit connector 7 and the printing unit connector 9A are automatically connected/disconnected by the attachment/detachment of the printing unit 5A to/from the frame drive unit 4.

When the frame drive unit connector 7 and the printing unit connector 9A are connected, the control unit 79 of the printing unit 5A is connected to the sensors 46 and 47 of the frame drive unit 4, the drive circuits 39a and 45a and the data storage 48. Electricity is supplied to the frame drive unit 4 via the printing unit 5A from the household power supply 6 and the frame drive motor 39 and 45 are driven by the control unit 79. As described above, the sewing machine body connector 8 and the printing unit connector 9A assume the same structure. The print head 70 and the cartridge attachment portion, and the like, provided in the upper side thereof are the same as the first embodiment, hence no description will be given therefore.

The head position switch mechanism 71 includes a guide shaft 80 functioning as a pivot portion having the print head 70 and the carrier mechanism 78 pivoted integrally about a laterally oriented shaft, and a head rotating mechanism 81 including an electric head rotating motor 82 that rotates the print head 70. The head rotating mechanism 81 is arranged to rotate the print head 70, thereby to switch the disposition of the print head 70 between the printing position and the nonprinting position by longitudinally moving the purge unit 77 guided by laterally paired guide rods 77a.

The head rotating mechanism 81 includes a head rotating motor 82, a rack 84 provided in the upper surface of the purge unit 77 casing and arranged in mesh engagement with a drive pinion 83 of the head rotating motor 82, an engagement groove 85 formed in a side wall of the purge unit 77 casing, and an arm 87 pivoted to the guide shaft 80. The arm 87 has one end thereof fixed with a follower 86 engaging with the engagement groove 85 and the other end thereof connected to a frame 78a.

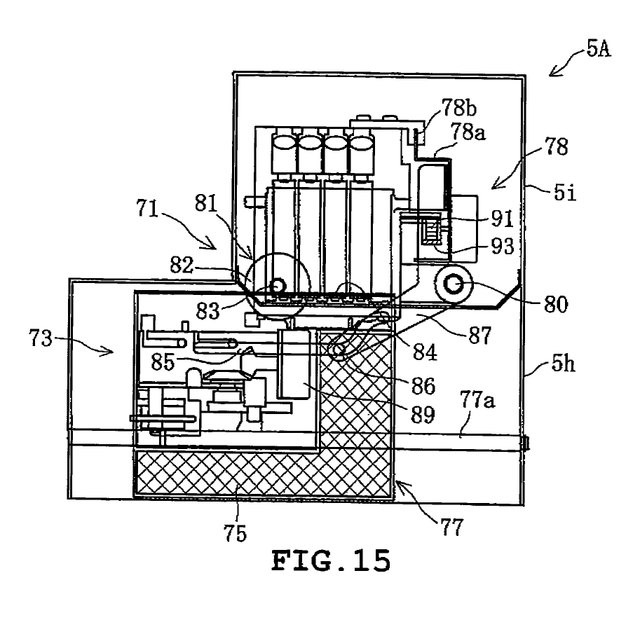

When the purge unit 77 is positioned between a first position shown in FIG. 14 and a second position shown in FIG. 15, the follower 86 is engaged with a horizontal groove of the engagement groove 86 to maintain the downwardly oriented vertical disposition of the print head 70. Then, as shown in FIG. 13, when the print head 70 is positioned in the left end portion of the arm 5i, the print head 70 assumes the printing position projecting below the arm 51 and is placed in close proximity of the workpiece cloth W held by the cloth holding frame 3.

When the purge unit 77 is positioned forward relative to the second position shown in FIG. 15, the follower 86 is engaged with a cam groove of the engagement groove 85, moving the purge unit 77 longitudinally, and the follower 86 engages with the cam groove of the engagement groove 85, thereby rotating the print head 70 integrally with the arm 87. When the purge unit 77 is disposed in the third position shown in FIG. 16, the print head 70 assumes the nonprinting position inclined by approximately 15 degrees from the downwardly oriented vertical disposition, whereby the print head 70 is disposed upward relative to the bottom plate of the arm 5i and rendered laterally movable inside the arm 5i.

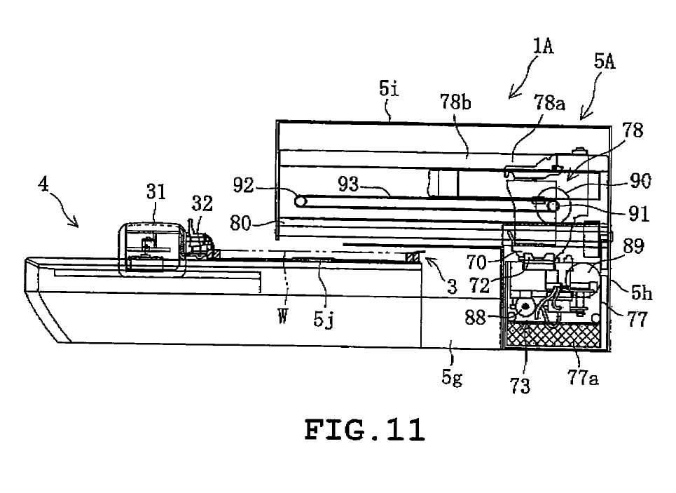

The head cap 72 and the purging mechanism 73 take on the same structure as the head cap 52 and the purging mechanism 53 of the first embodiment, where the purging mechanism 73 includes a suction pump 88 and a purge drive motor 89. When the purge unit 77 is disposed in the first position shown in FIG. 14, the nozzles of the print head 70 is covered by the head cap 72 with the print head 70 disposed in the purging position assuming a downwardly oriented vertical disposition as shown in FIGS. 10 and 11, thereby enabling the purging of the print head 70 by the purging mechanism 53.

The nozzle wiper 74 is provided to the rear side of the head cap 72 and to the front side of the nozzles of the print head disposed in the purging position, with the purge unit 77 assuming the second position shown in FIG. 15. After purging the print head 70 by the purging mechanism 73, the print head 70 contacts the nozzle wiper 74 and is wiped thereby upon moving the purge unit 77 from the first position to the second position, thereby cleaning the purged ink remaining in the nozzle surface of the print head 70.

The flushing position is taken when the purge unit 77 is disposed in the third position shown in FIG. 16, and the print head 70 is disposed in the purging position, and the upper surface of the waste-ink absorbing felt 75 is positioned below the print head 70. The waste ink flushed from the print head 70 is ejected directly on the waste-ink absorbing felt 75 and absorbed thereby.

Inside the head 5i, a laterally oriented guide shaft 80 and the frame 78a pivoted to the guide shaft 80 are provided across the entire lateral length of the head 5i. A guide rail 78b is formed integrally on the upper end of the frame 78a and the print head 70 is guided by the guide shaft 80 and the guide rail 78b. That is, when the frame 78a is rotated by the head rotating mechanism 81, the print head 70 being engaged with the guide rail 78b and the guide shaft 80 is rotated integrally with the frame 78a while maintaining the engagement.

The carrier mechanism 78 is provided inside the arm 5i, and is provided with an electric head moving motor 90 that laterally drives the print head 70. The head moving motor 90 is fixed on the right end of the frame 78a and a pinion 91 is mounted on the output shaft thereof. A pinion 92 is pivoted on the left end of the frame 78b and an endless belt 93 is wound on the pinion 91 and 92, the print head 70 being connected to the endless belt 93. Thus, the carrier member 78 is capable of driving the print head 70 in the lateral direction regardless of the rotary disposition of the print head 70.

In the printer with embroidering function 1A, as shown in FIG. 1, the predetermined sewing base position B1 of the sewing needle 11 when the sewing machine main body 2 is attached to the frame drive unit 4 and the predetermined printing base position B3 of the print head 70 when the printing unit 5A is attached to the frame drive unit 4 are matched. Further, when the sewing machine body 2 is attached to the frame drive unit 4, the sewing base position B1 is set so that the sewing needle 11 matches with the center of the maximum movement area covered by the cloth holding frame 3 moved to the maximum extent by the frame drive unit 4. Further, when the printing unit 5A is attached to the frame drive unit 4, the printing base position B3 is set so that the center of the print head 70 matches with the center of the aforementioned maximum movement area. The center of the print head 70 indicates the center of the plurality of nozzles of the print head 70.

Next, a description will be given on the operation and effect of the printer with embroidering function 1A. However, the operation and effect that is substantially the same as the printer with embroidering function 1 of the first embodiment will not be described.

The printing unit 5A is detachably attached to the attachment portion 4a of the frame drive unit separated from the sewing machine body 2. As shown in FIGS. 10 to 13, the electrical systems of the printing unit 5A shown in FIG. 17 and the frame drive unit 4 are connected by the connectors 7 and 9A with the printing unit 5A attached to the frame drive unit 4. In case the printing unit 5A is not attached to the frame drive unit 4 or when a print operation is not executed even if the printing unit 5A is attached to the frame drive unit 4 as shown in FIGS. 10 and 11, the print head 70 is disposed in the purging position and the purge unit 77 is disposed in the first position shown in FIG. 14 with the nozzles of the print head 70 being covered by the head cap 72.

Also, when removing the printing unit 5A from the frame drive unit 4, the print head 70 is disposed in the purging position and a relatively large space is created between the bed 5g and the distal end of the arm 5i. Thus, when attaching/detaching the printing unit 5A to/from the frame drive unit 4 with the cloth holding frame 3 connected to the frame drive unit 4, the attachment/detachment can be carried out reliably without the print head 70, or the like, interfering with the cloth holding frame 3. Also, when the printing unit 5A is attached to the frame drive unit 4, a cloth positioning portion 5j of the bed 5g contacts the workpiece cloth W held by the cloth holding frame 3 from the underside, thereby stretching at least the printing portion of the workpiece cloth W.

When a printing process is executed with the printing unit 5A attached to the frame drive unit 4, first, the purge drive motor 89 is driven by the control unit 79 while maintaining the state of FIGS. 10 and 11, thereby executing a purging operation on the print head 70 by the purging mechanism 73. Then, the head rotation motor 82 is driven by the control unit 79 and the purge unit 77, being carried forward relative to the first position, is switched from the first position to the second position by the head rotating mechanism 81, and the nozzles of the print head 70 are wiped by the nozzle wiper 74 provided in the purge unit 77 in the meantime.

Next, as shown in FIG. 16, when the purge unit 77 is switched to the third position by being carried forward from the second position, the print head 70 is rotated and is positioned above the bottom plate of the arm 5i. At this time, the waste-ink absorbing felt 75 is positioned below the nozzle of the print head 70 and when the flushing operation is executed, ink is ejected directly to the waste-ink absorbing felt 75 from the nozzle and absorbed by the waste-ink absorbing felt 75.

Next, the head moving motor 90 is driven by the control unit 79 and the print head 70 is carried leftward and switched to the printable position. Subsequently, the head rotating motor 82 is driven and as shown in FIG. 15, the purge unit 77 is carried rearward from the third position to the second position, thereby switching the print head 70 to the printing position assuming the downwardly oriented vertical disposition. In this state, based on the printing data, the frame drive motor 39 and 45 are driven by the control unit 79 of the printing unit SA, then the cloth holding frame 3 connected to the frame drive unit 4 is moved independently in the longitudinal and lateral directions, and the print head 70 is driven by the control unit 79, thereby printing the workpiece cloth W held by the cloth holding frame 3 and the embroidery patterns formed on the workpiece cloth W.

In flushing the print head 70 at appropriate intervals during the printing process, the printing process is tentatively stopped and the print head 70 is lifted to the nonprinting position by the head position switch mechanism 71 and the print head 70 is switched to the flushing position by the carrier mechanism 78 and thereby flushed. Thereafter, the print head 70 is returned to the printing position by the reverse operation to restart the printing process.

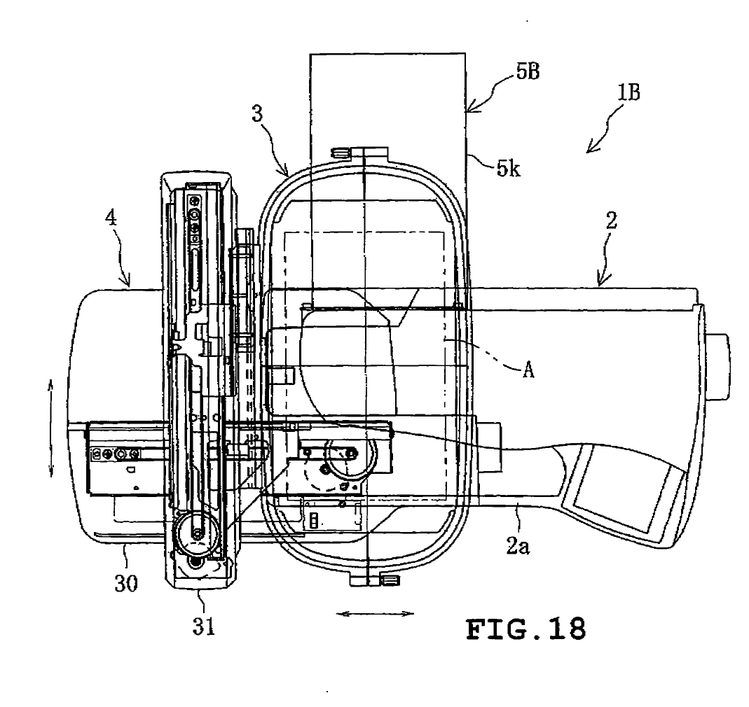

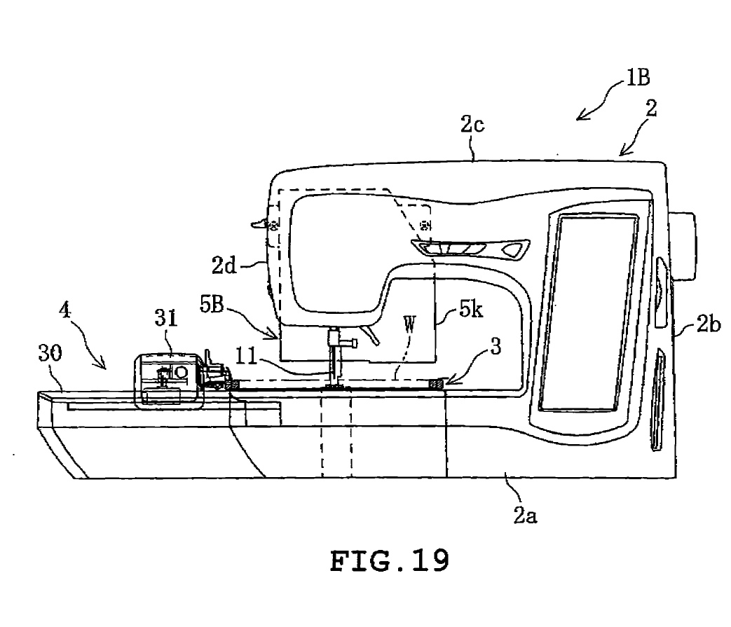

Next, a third embodiment will be described with reference to FIGS. 18 to 23.

A printer with embroidering function 1B of a third embodiment, as shown in FIGS. 18 to 23, includes a sewing machine body 2 capable of sewing a workpiece cloth W, a cloth holding frame 3 that holds the workpiece cloth to be sewn, a frame drive unit 4 detachably attaching to the bed 2a of the sewing machine body 2 and having the cloth holding frame 3 connected therewith to moving the cloth holding frame 3 in the longitudinal and the lateral directions(two perpendicular directions in the horizontal plane), and the ink-jet printing unit 5B capable of printing the workpiece cloth W held by the cloth holding frame 3 moved by the frame drive unit 4.

The printing unit 5B is fixed on the rear side of the head 2e of the sewing machine body 2. That is, the sewing machine body 2 and the printing unit 5B are provided integrally, being aligned in the longitudinal direction. The printing unit 5B may be fixed to the arm 2c of the sewing machine body 2 or to the rear side of the foot 2b, or maybe fixed across a plurality of the foregoing portions 2b, 2c, and 2e including the head 2e. The frame drive unit 4 is provided removably or removably to the bed 2a of the sewing machine body 2. In arranging the frame drive unit 4 detachably to the bed 2a of the sewing machine body 2, it is preferable to provide connectors 7 and 8 as in the first embodiment. The sewing machine body 2, cloth holding frame 3, and the frame drive unit 4 of the printer with embroidering function 1B is substantially the same as the printer with embroidering function 1 of the first embodiment, therefore have been represented by the reference symbols identical to the first embodiment and hence will not be described in detail.

The printing unit 55 will be described detail.

As shown in FIGS. 18 to 23, the printing unit 5B is provided in a printing machine frame 5k connected to the rear side of a head 2d of the sewing machine body 2. The printing unit 5B includes a print head 100, a head position switch mechanism 101, a head cap 102 that covers the nozzle of the print head 100, a purging mechanism 103 for purging the print head 100, a nozzle wiper 104 of the print head 100, an ink receptacle 105 that receives the ink flushed from the print head 100 and a waste-ink absorbing felt 106 that receives and absorbs ink flushed and purged from the print head 100. The printing unit 5B is capable of color printing by ejecting four colors of from the print head 100.

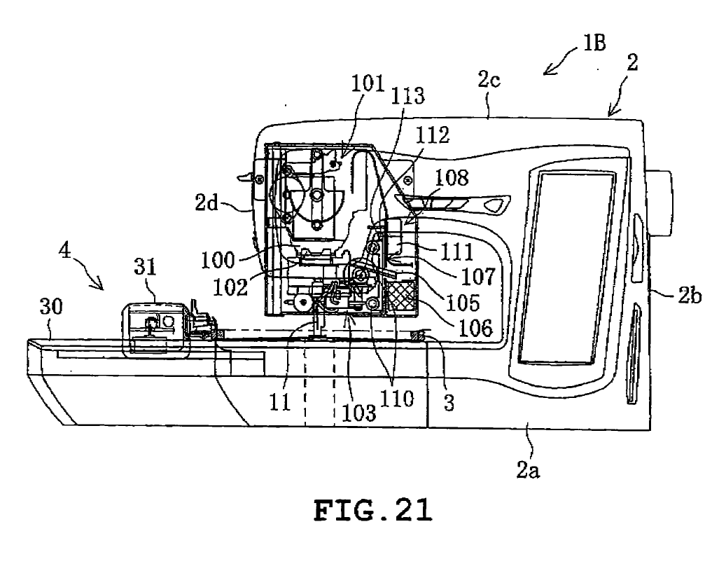

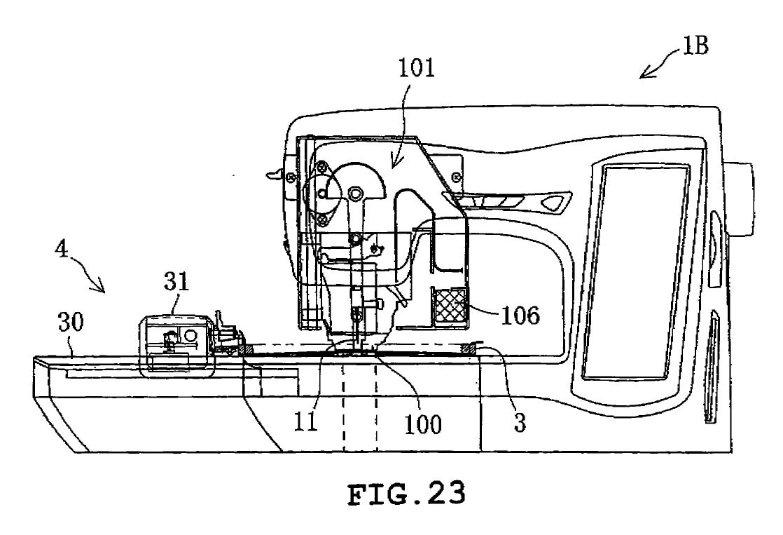

The head position switch mechanism 101 is arranged to switch the print head 100 between the printing position (refer to FIG. 23) in close proximity with the workpiece cloth W held by the cloth holding frame 3 which is connected to the frame drive unit 4 and the nonprinting position (refer to FIG. 21) spaced from the printing position. The head cap 102, the nozzle wiper 104, the waste-ink absorbing felt 105 are provided in the purging mechanism 103, the purge unit 107 is constituted by attaching the members 102 to 105 to the casing.

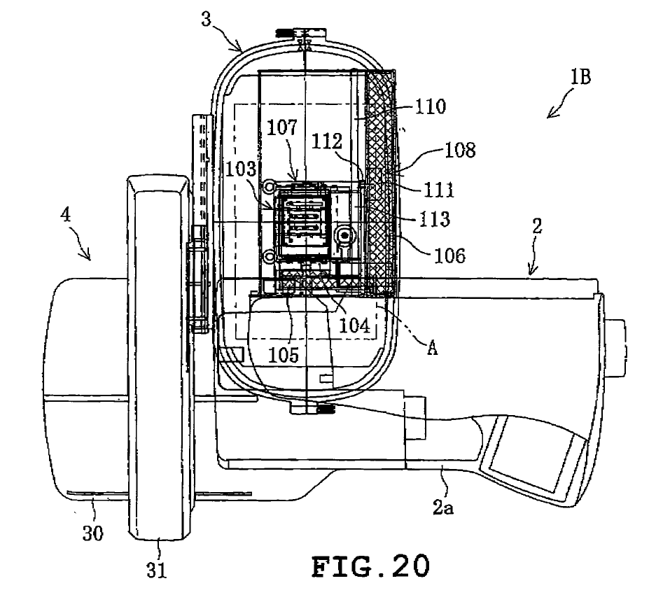

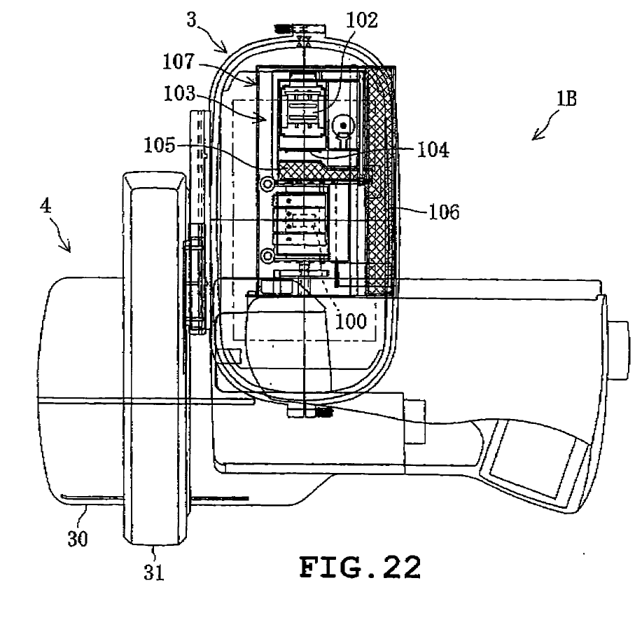

The printing unit 5B has a carrier member 108 that carries the purging mechanism 103 (purge unit 107) longitudinally relative to the print head 100. The carrier mechanism 108 is arranged to switch the purging mechanism 103 between the purging position (refer to FIG. 20) capable of executing a purging operation, and a printable position (refer to FIG. 22) enabling the print operation and spaced reward relative to the purging position, and a flushing position (interposing the purging position and the printable position) capable of receiving the ink drawn from the flushing operation by the ink receptacle.

The print head 100 and the head position switch mechanism 101 are provided in the front portion of the printing machine frame 5k. The cartridge attachment portion, the head position switch mechanism 101, the head cap 102 and the purging mechanism 103 assume the same structure described in the first embodiment, hence will not be described in detail. The nozzle wiper 54 is provided in the opposite side (further reward of the head cap 102) of the printable position relative to the head cap 102 and at level with the nozzles of the print head 100 assuming the nonprinting position.

The ink receptacle 105 comprises an open-top container disposed in a rightwardly downward incline, and is situated in the purging position side (rearward relative to nozzle wiper 104) relative the nozzle wiper 104, with the purging mechanism 103 disposed in the printable position. The waste-ink absorbing felt 106 is provided in the right end of the printing machine frame 5k across the entire longitudinal length thereof. The waste-ink absorbing felt 106 is disposed in the right side of the ink receptacle 105 irrespective of the position of the purging mechanism 103, and the ink received by the ink receptacle 105 is drained down the ink receptacle 105 to be absorbed by the waste-ink absorbing felt 106.

Inside the printing machine frame 5k, a pair of upper and lower guide rails 110 is disposed in the longitudinal direction, so as to extend fully across the longitudinal length of the frame 5k, and a purge unit 107 is guided by the guide rails 110. The carrier mechanism 108 is provided inside the printing machine frame 5k and is provided with an electric purge carrier motor ill that drives the purge unit 117 inclusive of the purging mechanism 103, and the like, in the longitudinal direction. The purge carrier motor ill is fixed to a frame disposed in the longitudinal mid portion of the printing machine frame 5k, a pinion 112 mounted on the output shaft of the purge carrier motor 69 is placed in mesh engagement with a pinion 112 formed in the right end upper surface of the purge unit 107.

As shown in FIGS. 18 and 20, the reference symbol A inside the cloth holding frame 3 connected to the frame drive unit 4 indicates a sewable and printable area allowing both sewing and printing to be executed by moving the cloth holding frame 3 by the frame drive unit 4. In order to obtain the sewable and printable area, the amount of movement of the cloth holding frame 3 rendered by the frame drive unit 4 is set based on the distance between the sewing machine body 2 and the sewing needle 11 and the printing unit 5A and the print head 100.

Next, a description will be given on the operation and effect of the printer with embroidering function B1.

In executing a sewing operation, the cloth holding frame 3 connected to the frame drive unit 4 is placed in condition for a sewing operation by positioning the same below the sewing needle 11 of the sewing machine body 2, where after the cloth holding frame 3 is moved independently in two mutually perpendicular directions on a horizontal plane by the frame drive unit 4, thereby forming embroidery patterns on the workpiece cloth W held by the cloth holding frame 3 by executing a sewing operation by the sewing machine main body 2. In executing a print operation, the cloth holding frame 3 connected to the frame drive unit 4 is placed in condition for a print operation by positioning the same below the print head 100 of the printing unit 5B, where after the cloth holding frame 3 is moved independently in two mutually perpendicular directions on a horizontal plane by the frame drive unit 4, thereby forming printing patterns on the workpiece cloth W held by the cloth holding frame 3 by executing a print operation by the printing unit 5B.

At this time, when switching between the sewable state and the printable state, the cloth holding frame 3 is arranged to be longitudinally displaced (offset) by the distance between the sewing needle 11 of the sewing machine body 2 and the print head 100 of the printing unit 5B. Thus, both sewing and print operations can be executed on the workpiece cloth w without having to rearrange the hold of the workpiece cloth by the cloth holding frame 3. Particularly, since the sewing machine body 2 and the printing unit 5B have been provided integrally, both sewing and print operations can be executed on the workpiece cloth W held by the cloth holding frame 3 with the cloth holding frame 3 connected to the frame drive unit 4 and without further attachment/detachment.

Upon executing a purging operation, since the purging mechanism 103 and the print head 100 are isolated from the workpiece cloth W held by the cloth holding frame 3 which is connected to the frame drive unit 4, the ink dripping from the purging mechanism 103 and the print head 100 can be prevented from landing on the workpiece cloth W connected to the frame drive unit 4, thereby keeping the workpiece cloth W clean. The same effect can be obtained from the printer with embroidering function 1 and 1A of the first and the second embodiment. Other aspects of the present embodiment basically have the same operation and effects as the first embodiment.

The printer with embroidering function of the present invention can be modified or expanded within the scope of the invention.

### INDUSTRIAL APPLICABILITY

As described above, the printer with embroidering function of the present invention is a printer that prints patterns on the workpiece cloth which is suitable for household use and is further useful as a printer with embroidering function which incorporates the function of an embroidery sewing machine to such household printers.

1. A printer with embroidering function including a sewing machine body capable of sewing a workpiece cloth, a cloth holding frame holding the workpiece cloth to be sewn, a frame drive unit having the cloth holding frame connected therewith to move the cloth holding frame independently in two perpendicular directions on a horizontal plane, the printer with embroidering function having an ink-jet printer capable of printing the workpiece cloth of the cloth holding frame moved by the frame drive unit comprising:
a purging mechanism capable of purging a print head of the printing unit;
a carrier mechanism characterized by being capable of switching the purging mechanism or the print head between a purging position capable of purging the print head and a printable position spaced from the purging position and capable of printing by relatively moving the purging mechanism or the print head in a horizontal direction.

2. The printer with embroidering function according to claim 1, characterized in that the carrier mechanism carries the purging mechanism in the horizontal direction.

3. The printer with embroidering function according to claim 1, characterized in that the carrier mechanism carries the print head in the horizontal direction.

4. The printer with embroidering finction according to claims 1 or 2 or 3, characterized in that upon print operation, the purging mechanism and the print head are isolated from the workpiece cloth of the cloth holding frame connected to the frame drive unit.

5. The printer with embroidering function according to claim 4, characterized in that the purging mechanism and the print head being isolated from the workpiece cloth of the cloth holding frame are disposed outside a printable range of the workpiece cloth.

6. The printer with embroidering function according to claims 1 or 2 or 3, characterized in that the purging mechanism further comprises a nozzle wiper for the print head, wherein upon moving the purging mechanism or the print head from the purging position to the printable position, the print head is wiped by the nozzle wiper.

7. The printer with embroidering function according to claims 1 or 2 or 3, characterized in further comprising an ink receptacle capable of receiving flushed ink, wherein the carrier mechanism is capable of switching the purging mechanism or the print head to a flushing position allowing reception of flushed ink by the ink receptacle.

8. The printer with embroidering finction according to claims 1 or 2 or 3, characterized in further comprising a head position switch mechanism that switches the print head between a printing position in close proximity of the workpiece cloth of the cloth holding frame connected to the frame drive unit and a nonprinting position upwardly spaced from the printing position.

9. The printer with embroidering function according to claim 8, characterized in that the head position switch mechanism comprises head guide portions that guide the print head vertically movably and an electric motor that vertically drives the print head.

10. The printer with embroidering function according to claim 8, characterized in that the head position switch mechanism comprises a head pivot portion that rotates the print head about a horizontal shaft and an electric motor that rotates the print head.

11. The printer with embroidering function according to claims 1 or 2 or 3, characterized in that the printing unit is fixed in a rear side of at least either of a sewing machine body head, an arm or a foot.

12. The printer with embroidering function according to claim 11 characterized in that the sewing machine body and the printing unit are aligned in the horizontal direction, wherein a movement amount of the cloth holding frame by the frame drive unit is set based on a distance between a sewing needle of the sewing machine body and print head of the printing unit to obtain a sewable and a printable area of a predetermined size within the cloth holding frame connected to the frame drive unit.
